(19) United States
(12) Patent Application Publication
(10) Pub. No.: US 2022/0101000 A1
(43) Pub. Date: Mar. 31, 2022

(54) QR GENERATION SYSTEM FOR AUGMENTED REALITY CONTINUITY

(71) Applicant: Snap Inc., Santa Monica, CA (US)

(72) Inventors: Yu Jiang Tham, Los Angeles, CA (US); Andrés Monroy-Hernándes, Seattle, WA (US); Rajan Vaish, Bererly Hills, CA (US)

(21) Appl. No.: 16/949,112

(22) Filed: Oct. 14, 2020

Related U.S. Application Data
(60) Provisional application No. 63/085,632, filed on Sep. 30, 2020.

(51) Int. Cl. G06K 9/00; G06K 7/14

(52) U.S. Cl. CPC G06K 9/00671; G06K 7/1417

(57) ABSTRACT

Systems and Methods directed to detecting first user activity during a first session of an interactive augmented reality (AR) application on a first computing device, generating a quick response (QR) image comprising an encoded AR state associated with the first user activity, retrieving the QR image during a second session of the interactive AR application, and detecting selection of the QR image during the second session. The systems and methods are include generating an AR environment based on the encoded AR state in response to detecting the selection of the QR image, and causing an AR application interface associated with the interactive AR application to display the AR environment during the second session.

### CLAIM OF PRIORITY

This application claims the benefit of priority to U.S. Provisional Application Ser. No. 63/085,632, filed on Sep. 30, 2020, which is incorporated herein by reference in its entirety.

### BACKGROUND

As the popularity of mobile-based social networking systems continues to grow, users increasingly share and access programs, games, or media content items, such as photos or videos with each other. In many cases, augmented reality (AR) applications, AR games, and other forms of media content items are typically uniquely personalized, and thus, reflect a demand to encourage multiplayer collaboration and electronic visual communication on a global scale.

Social networking systems comprise millions of users. Each user in a social networking system can receive, access, and transmit AR games and applications between members within her individual social networking profile or to individuals outside of the social networking profile.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings in which:

FIG. 1 is a diagrammatic representation of a networked environment in which the present disclosure may be deployed, in accordance with some examples.

FIG. 2 is a diagrammatic representation of a messaging system, in accordance with some examples, that has both client-side and server-side functionality.

FIG. 3 is a diagrammatic representation of a data structure as maintained in a database, in accordance with some examples.

FIG. 4 is a diagrammatic representation of a message, in accordance with some examples.

FIG. 5 is a flowchart for an access-limiting process, in accordance with some examples.

FIG. 6 illustrates a diagrammatic representation of at least some details of the QR generation system in accordance with some examples.

FIG. 7 is an interface diagram illustrating a user interface of the AR application interface displaying a user actively engaged in an AR application in accordance with some examples.

FIG. 8 is an interface diagram illustrating a user interface of the AR application interface displaying a user actively completing an AR application in accordance with some examples.

FIG. 9 is an interface diagram illustrating a user interface of the AR application interface displaying a second user actively beginning a new session in the AR application in accordance with some examples.

FIG. 10 is an interface diagram illustrating a user interface of the AR application interface displaying a second user selecting an AR image in the new session of the AR application in accordance with some examples.

FIG. 11 is an interface diagram illustrating a user interface of the AR application interface displaying the second user actively engaged in an AR application during the second session after accessing the QR image in accordance with some examples.

FIG. 12 is a flowchart illustrating a method 1200 for generating a QR image associated with an AR application state in accordance with some examples.

FIG. 13 is a diagrammatic representation of a machine in the form of a computer system within which a set of instructions may be executed for causing the machine to perform any one or more of the methodologies discussed herein, in accordance with some examples.

FIG. 14 is a block diagram showing a software architecture within which examples may be implemented.

FIG. 15 is a diagrammatic representation of a processing environment, in accordance with some examples.

### DETAILED DESCRIPTION

As the rise in multiplayer gaming applications, media applications, and other AR applications and experiences for social media networking systems continue to increase, it becomes increasingly difficult to synchronize one user's gaming activities or progress with another user's experience. For instance, if a first user accesses a multiplayer building block game and interactively builds a foundation of a castle, the first user's progress of building that castle is unable to be saved and retrieved by a second user who signs into the multiplayer building block game at a later date or time. Thus, the second user would have to start building the foundation of the castle all over again without any consideration as to the progress made by the first user of the multiplayer building block game.

In industry today, AR media and gaming applications are programmed and confirmed for smartphone devices which are more complexed in technical structure, memory, and graphical processing. Due to the networking and digital complexities, current social media networking systems do not utilize communication to third party backend services for privacy and security reasons resulting in reduced continuity between multiple users' progress and activities achieved in multiplayer AR gaming and experiences.

In at least one example, a system is provided that generates a scannable image, such as a quick response (QR) code, that is encoded with a user's progress, status, actions, and activities achieved during a multiplayer AR gaming application session. Once the QR code is generated and encoded with the user's progress, status, and activity information, it can be transmitted to a second user who is actively engaged or inactive within the multiplayer AR application. If the second user is inactive in the AR application, when the second user signs into the multiplayer AR application, the QR code is received after being transferred to the second user and used to generate and display a recreated AR environment based on the encoded information (e.g., user progress, status, and activities) achieved during the previous gaming session by the initial user. This way, the second user can resume where the initial user left off in the AR application.

Networked Computing Environment

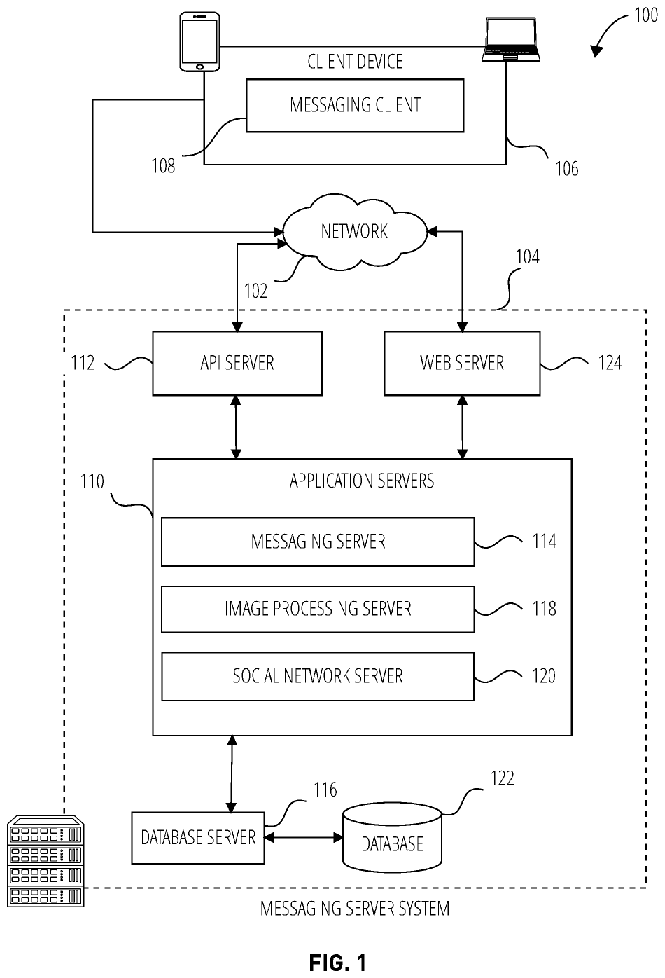

FIG. 1 is a block diagram showing an example messaging system 100 for exchanging data (e.g., messages and associated content) over a network. The messaging system 100 includes multiple instances of a client device 106, each of which hosts a number of applications, including a messaging client 108. Each messaging client 108 is communicatively coupled to other instances of the messaging client 108 and a messaging server system 104 via a network 102 (e.g., the Internet).

A messaging client 108 is able to communicate and exchange data with another messaging client 108 and with the messaging server system 104 via the network 102. The data exchanged between messaging client 108, and between a messaging client 108 and the messaging server system 104, includes functions (e.g., commands to invoke functions) as well as payload data (e.g., text, audio, video or other multimedia data).

The messaging server system 104 provides server-side functionality via the network 102 to a particular messaging client 108. While certain functions of the messaging system 100 are described herein as being performed by either a messaging client 108 or by the messaging server system 104, the location of certain functionality either within the messaging client 108 or the messaging server system 104 may be a design choice. For example, it may be technically preferable to initially deploy certain technology and functionality within the messaging server system 104 but to later migrate this technology and functionality to the messaging client 108 where a client device 106 has sufficient processing capacity.

The messaging server system 104 supports various services and operations that are provided to the messaging client 108. Such operations include transmitting data to, receiving data from, and processing data generated by the messaging client 108. This data may include message content, client device information, geolocation information, media augmentation and overlays, message content persistence conditions, social network information, and live event information, as examples. Data exchanges within the messaging system 100 are invoked and controlled through functions available via user interfaces (UIs) of the messaging client 108.

Turning now specifically to the messaging server system 104, an Application Program Interface (API) server 112 is coupled to, and provides a programmatic interface to, application servers 110. The application servers 110 are communicatively coupled to a database server 116, which facilitates access to a database 122 that stores data associated with messages processed by the application servers 110. Similarly, a web server 124 is coupled to the application servers 110, and provides web-based interfaces to the application servers 110. To this end, the web server 124 processes incoming network requests over the Hypertext Transfer Protocol (HTTP) and several other related protocols.

The Application Program Interface (API) server 112 receives and transmits message data (e.g., commands and message payloads) between the client device 106 and the application servers 110. Specifically, the Application Program Interface (API) server 112 provides a set of interfaces (e.g., routines and protocols) that can be called or queried by the messaging client 108 in order to invoke functionality of the application servers 110. The Application Program Interface (API) server 112 exposes various functions supported by the application servers 110, including account registration, login functionality, the sending of messages, via the application servers 110, from a particular messaging client 108 to another messaging client 108, the sending of media files (e.g., images or video) from a messaging client 108 to a messaging server 114, and for possible access by another messaging client 108, the settings of a collection of media data (e.g., story), the retrieval of a list of friends of a user of a client device 106, the retrieval of such collections, the retrieval of messages and content, the addition and deletion of entities (e.g., friends) to an entity graph (e.g., a social graph), the location of friends within a social graph, and opening an application event (e.g., relating to the messaging client 108).

The application servers 110 host a number of server applications and subsystems, including for example a messaging server 114, an image processing server 118, and a social network server 120. The messaging server 114 implements a number of message processing technologies and functions, particularly related to the aggregation and other processing of content (e.g., textual and multimedia content) included in messages received from multiple instances of the messaging client 108. As will be described in further detail, the text and media content from multiple sources may be aggregated into collections of content (e.g., called stories or galleries). These collections are then made available to the messaging client 108. Other processor and memory intensive processing of data may also be performed server-side by the messaging server 114, in view of the hardware requirements for such processing.

The application servers 110 also include an image processing server 118 that is dedicated to performing various image processing operations, typically with respect to images or video within the payload of a message sent from or received at the messaging server 114.

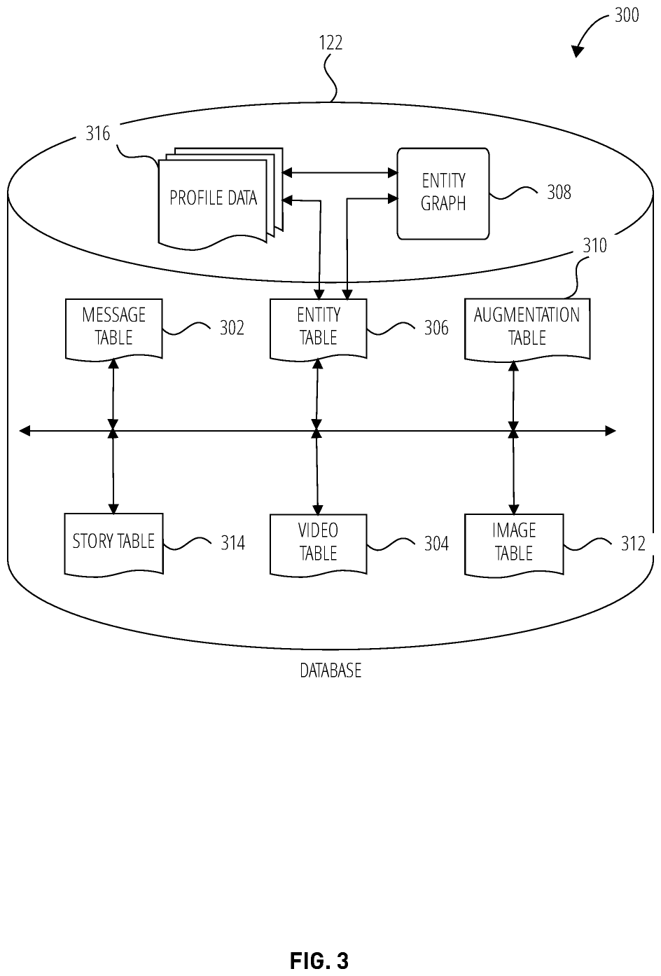

The social network server 120 supports various social networking functions and services and makes these functions and services available to the messaging server 114. To this end, the social network server 120 maintains and accesses an entity graph 308 (as shown in FIG. 3) within the database 122. Examples of functions and services supported by the social network server 120 include the identification of other users of the messaging system 100 with which a particular user has relationships or is “following,” and also the identification of other entities and interests of a particular user.

System Architecture

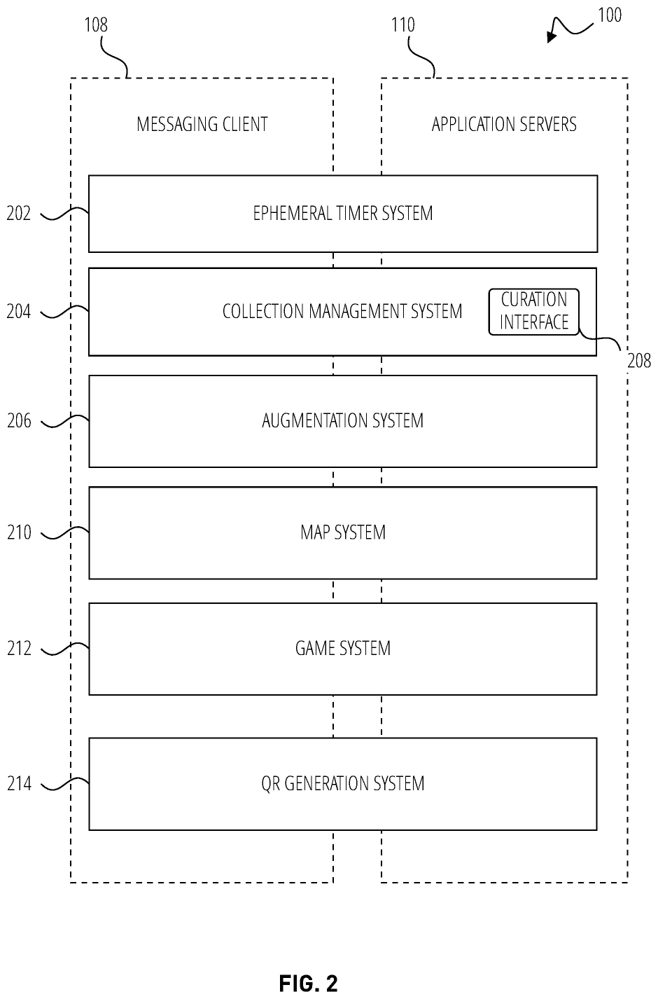

FIG. 2 is a block diagram illustrating further details regarding the messaging system 100, according to some examples. Specifically, the messaging system 100 is shown to comprise the messaging client 108 and the application servers 110. The messaging system 100 embodies a number of subsystems, which are supported on the client-side by the messaging client 108 and on the sever-side by the application servers 110. These subsystems include, for example, an ephemeral timer system 202, a collection management system 204, an augmentation system 206, a map system 210, a game system 212, and a QR generation system 214.

The ephemeral timer system 202 is responsible for enforcing the temporary or time-limited access to content by the messaging client 108 and the messaging server 114. The ephemeral timer system 202 incorporates a number of timers that, based on duration and display parameters associated with a message, or collection of messages (e.g., a story), selectively enable access (e.g., for presentation and display) to messages and associated content via the messaging client 108. Further details regarding the operation of the ephemeral timer system 202 are provided below.

The collection management system 204 is responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client 108.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain examples, compensation may be paid to a user for the inclusion of user-generated content into a collection. In such cases, the collection management system 204 operates to automatically make payments to such users for the use of their content.

The augmentation system 206 provides various functions that enable a user to augment (e.g., annotate or otherwise modify or edit) media content associated with a message. For example, the augmentation system 206 provides functions related to the generation and publishing of media overlays for messages processed by the messaging system 100. The augmentation system 206 operatively supplies a media overlay or augmentation (e.g., an image filter) to the messaging client 108 based on a geolocation of the client device 106. In another example, the augmentation system 206 operatively supplies a media overlay to the messaging client 108 based on other information, such as social network information of the user of the client device 106. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo) at the client device 106. For example, the media overlay may include text or image that can be overlaid on top of a photograph taken by the client device 106. In another example, the media overlay includes an identification of a location overlay (e.g., Venice beach), a name of a live event, or a name of a merchant overlay (e.g., Beach Coffee House). In another example, the augmentation system 206 uses the geolocation of the client device 106 to identify a media overlay that includes the name of a merchant at the geolocation of the client device 106. The media overlay may include other indicia associated with the merchant. The media overlays may be stored in the database 122 and accessed through the database server 116.

In some examples, the augmentation system 206 provides a user-based publication platform that enables users to select a geolocation on a map and upload content associated with the selected geolocation. The user may also specify circumstances under which a particular media overlay should be offered to other users. The augmentation system 206 generates a media overlay that includes the uploaded content and associates the uploaded content with the selected geolocation.

In other examples, the augmentation system 206 provides a merchant-based publication platform that enables merchants to select a particular media overlay associated with a geolocation via a bidding process. For example, the augmentation system 206 associates the media overlay of the highest bidding merchant with a corresponding geolocation for a predefined amount of time.

The map system 210 provides various geographic location functions, and supports the presentation of map-based media content and messages by the messaging client 108. For example, the map system 210 enables the display of user icons or avatars (e.g., stored in profile data 316) on a map to indicate a current or past location of “friends” of a user, as well as media content (e.g., collections of messages including photographs and videos) generated by such friends, within the context of a map. For example, a message posted by a user to the messaging system 100 from a specific geographic location may be displayed within the context of a map at that particular location to “friends” of a specific user on a map interface of the messaging client 108. A user can furthermore share his or her location and status information (e.g., using an appropriate status avatar) with other users of the messaging system 100 via the messaging client 108, with this location and status information being similarly displayed within the context of a map interface of the messaging client 108 to selected users.

The game system 212 provides various gaming functions within the context of the messaging client 108. The messaging client 108 provides a game interface providing a list of available games that can be launched by a user within the context of the messaging client 108, and played with other users of the messaging system 100. The messaging system 100 further enables a particular user to invite other users to participate in the play of a specific game, by issuing invitations to such other users from the messaging client 108. The messaging client 108 also supports both the voice and text messaging (e.g., chats) within the context of gameplay, provides a leaderboard for the games, and also supports the provision of in-game rewards (e.g., coins and items).

The QR generation system 214 provides QR images (e.g., codes) within the context of the messaging server system 104, messaging client 108, and Application servers 110. The operations of the game QR generation system 214 are executed at the messaging server system 104, messaging client 108, application servers 110, or third-party server. In some examples, the QR generation system 214 executes functions, routines, and operations including detecting a first user activity executed by a first computing device during an interactive augmented reality (AR) session of an interactive augmented reality AR application, generating a quick response (QR) image that is encoded with an AR state associated with the first user activity, retrieving the QR image during a second interactive AR session, and detecting the user's selection of the QR image during the second session. The first user activity corresponds to any progress, action, motion, or activity performed by the user of a computing device during an interactive AR session. In some examples, the AR state may be a past, present, or future status directly associated with the user's activity within the AR game or experience. The AR state may also correspond to the user's current or past gaming progress or activity.

In examples, the interactive AR session can be any AR application, including but not limited to, AR games, AR seminars, AR on-demand video, AR real-time video, AR medical simulation, AR military simulation, or AR experience. The QR generation system 214 may also be in communication with the game system 212 in order to receive the list of available games that can be launched by the user. Although AR applications and environments are disclosed, any interactive application, format, and environment is disclosed, such as two-dimensional applications, formats, or environments, three-dimensional format, applications, or environments, or virtual reality (VR) applications, formats, or environments.

The QR generation system 214 also provides functions including generating an AR environment based on the encoded AR state responsive to detecting the user selection of the QR image, and causing an AR application interface associated with the interactive AR application to display the AR environment during the second session.

Data Architecture

FIG. 3 is a schematic diagram illustrating data structures 300, which may be stored in the database 122 of the messaging server system 104, according to certain examples. While the content of the database 122 is shown to comprise a number of tables, it will be appreciated that the data could be stored in other types of data structures e.g., as an object-oriented database).

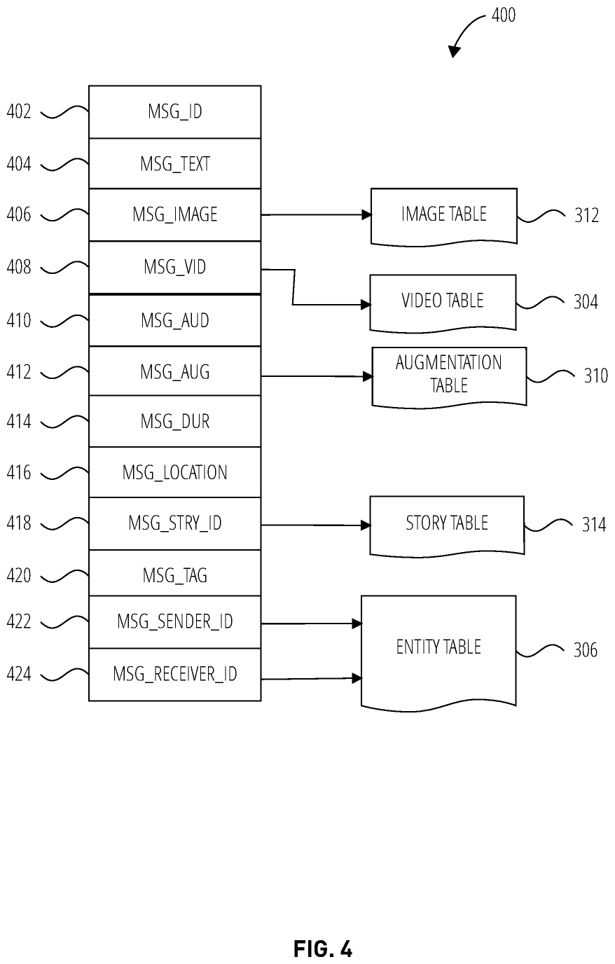

The database 122 includes message data stored within a message table 302. This message data includes, for any particular one message, at least message sender data, message recipient (or receiver) data, and a payload. Further details regarding information that may be included in a message, and included within the message data stored in the message table 302 is described below with reference to FIG. 4.

An entity table 306 stores entity data, and is linked (e.g., referentially) to an entity graph 308 and profile data 316. Entities for which records are maintained within the entity table 306 may include individuals, corporate entities, organizations, objects, places, events, and so forth. Regardless of entity type, any entity regarding which the messaging server system 104 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization) interested-based or activity-based, merely for example.

The profile data 316 stores multiple types of profile data about a particular entity. The profile data 316 may be selectively used and presented to other users of the messaging system 100, based on privacy settings specified by a particular entity. Where the entity is an individual, the profile data 316 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the messaging system 100, and on map interfaces displayed by messaging clients 108 to other users. The collection of avatar representations may include “status avatars,” which present a graphical representation of a status or activity that the user may select to communicate at a particular time.

Where the entity is a group, the profile data 316 for the group may similarly include one or more avatar representations associated with the group, in addition to the group name, members, and various settings (e.g., notifications) for the relevant group.

The database 122 also stores augmentation data, such as overlays or filters, in an augmentation table 310. The augmentation data is associated with and applied to videos (for which data is stored in a video table 304) and images (for which data is stored in an image table 312).

Filters, in one example, are overlays that are displayed as overlaid on an image or video during presentation to a recipient user. Filters may be of various types, including user-selected filters from a set of filters presented to a sending user by the messaging client 108 when the sending user is composing a message. Other types of filters include geolocation filters (also known as geo-filters), which may be presented to a sending user based on geographic location. For example, geolocation filters specific to a neighborhood or special location may be presented within a user interface by the messaging client 108, based on geolocation information determined by a Global Positioning System (GPS) unit of the client device 106.

Another type of filter is a data filter, which may be selectively presented to a sending user by the messaging client 108, based on other inputs or information gathered by the client device 106 during the message creation process. Examples of data filters include current temperature at a specific location, a current speed at which a sending user is traveling, battery life for a client device 106, or the current time.

Other augmentation data that may be stored within the image table 312 includes augmented reality content items (e.g., corresponding to applying Lenses or augmented reality experiences). An augmented reality content item may be a real-time special effect and sound that may be added to an image or a video.

As described above, augmentation data includes augmented reality content items, overlays, image transformations, AR images, and similar terms refer to modifications that may, be applied to image data (e.g., videos or images). This includes real-time modifications, which modify an image as it is captured using device sensors (e.g., one or multiple cameras) of a client device 106 and then displayed on a screen of the client device 106 with the modifications. This also includes modifications to stored content, such as video clips in a gallery that may be modified. For example, in a client device 106 with access to multiple augmented reality content items, a user can use a single video clip with multiple augmented reality content items to see how the different augmented reality content items will modify the stored clip. For example, multiple augmented reality content items that apply different pseudorandom movement models can be applied to the same content by selecting different augmented reality content items for the content. Similarly, real-time video capture may be used with an illustrated modification to show how video images currently being captured by sensors of a client device 106 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various embodiments, different methods for achieving such transformations may be used. Some examples may involve generating a three-dimensional mesh model of the object or objects, and using transformations and animated textures of the model within the video to achieve the transformation. In other examples, tracking of points on an object may be used to place an image or texture (which may be two dimensional or three dimensional) at the tracked position. In still further examples, neural network analysis of video frames may be used to place images, models, or textures in content images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated (e.g., using an Active Shape Model (ASM) or other known methods). Then, a mesh based on the characteristic points is generated for each of the at least one element of the object. This mesh used in the following stage of tracking the elements of the object in the video stream. In the process of tracking, the mentioned mesh for each element is aligned with a position of each element. Then, additional points are generated on the mesh. A first set of first points is generated for each element based on a request for modification, and a set of second points is generated for each element based on the set of first points and the request for modification. Then, the frames of the video stream can be transformed by modifying the elements of the object on the basis of the sets of first and second points and the mesh. In such method, a background of the modified object can be changed or distorted as well by tracking and modifying the background.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing color of areas; removing at least some part of areas from the frames of the video stream; including one or more new objects into areas which are based on a request for modification; and modifying or distorting the elements of an area or object. In various embodiments, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image with use of a specific face detection algorithm (e.g., Viola-Jones). Then, an Active Shape Model (ASM) algorithm is applied to the face region of an image to detect facial feature reference points.

In other examples, other methods and algorithms suitable for face detection can be used. For example, in some embodiments, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

In some examples, a search for landmarks from the mean shape aligned to the position and size of the face determined by a global face detector is started. Such a search then repeats the steps of suggesting a tentative shape by adjusting the locations of shape points by template matching of the image texture around each point and then conforming the tentative shape to a global shape model until convergence occurs. In some systems, individual template matches are unreliable, and the shape model pools the results of the weak template matches to form a stronger overall classifier. The entire search is repeated at each level in an image pyramid, from coarse to fine resolution.

A transformation system can capture an image or video stream on a client device (e.g., the client device 106) and perform complex image manipulations locally on the client device 106 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the client device 106.

In some examples, a computer animation model to transform image data can be used by a system where a user may capture an image or video stream of the user (e.g., a selfie) using a client device 106 having a neural network operating as part of a messaging client application 104 operating on the client device 106. The transformation system operating within the messaging client 108 determines the presence of a face within the image or video stream and provides modification icons associated with a computer animation model to transform image data, or the computer animation model can be present as associated with an interface described herein. The modification icons include changes that may be the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the client device 106 as soon as the image or video stream is captured, and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various embodiments, a modification may be persistent after an initial selection of a modification icon. The user may toggle the modification on or off by tapping or otherwise selecting the face being modified by the transformation system and store it for later viewing or browse to other areas of the imaging application. Where multiple faces are modified by the transformation system, the user may toggle the modification on or off globally by tapping or selecting a single face modified and displayed within a graphical user interface. In some embodiments, individual faces, among a group of multiple faces, may be individually modified, or such modifications may be individually toggled by tapping or selecting the individual face or a series of individual faces displayed within the graphical user interface.

A story table 314 stores data regarding collections of messages and associated image, video, or audio data, which are compiled into a collection (e.g., a story or a gallery). The creation of a particular collection may be initiated by a particular user (e.g., each user for which a record is maintained in the entity table 306). A user may create a “personal story” in the form of a collection of content that has been created and sent/broadcast by that user. To this end, the user interface of the messaging client 108 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from varies locations and events. Users whose client devices have location services enabled and are at a common location event at a particular time may, for example, be presented with an option, via a user interface of the messaging client 108, to contribute content to a particular live story. The live story may be identified to the user by the messaging client 108, based on his or her location. The end result is a “live story” told from a community perspective.

A further type of content collection is known as a “location story,” which enables a user whose client device 106 is located within a specific geographic location (e.g., on a college or university campus) to contribute to a particular collection. In some examples, a contribution to a location story may require a second degree of authentication to verify that the end user belongs to a specific organization or other entity (e.g., is a student on the university campus).

As mentioned above, the video table 304 stores video data that, in one example, is associated with messages for which records are maintained within the message table 302. Similarly, the image table 312 stores image data associated with messages for which message data is stored in the entity table 306. The entity table 306 may associate various augmentations from the augmentation table 310 with various images and videos stored in the image table 312 and the video table 304.

Data Communications Architecture

FIG. 4 is a schematic diagram illustrating a structure of a message 400, according to some examples, generated by a messaging client 108 for communication to a further messaging client 108 or the messaging server 114. The content of a particular message 400 is used to populate the message table 302 stored within the database 122, accessible by the messaging server 114. Similarly, the content of a message 400 is stored in memory as “in-transit” or “in-flight” data of the client device 106 or the application servers 110. A message 400 is shown to include the following example components:
message identifier 402: a unique identifier that identifies the message 400.
message text payload 404: text, to be generated by a user via a user interface of the client device 106, and that is included in the message 400.
message image payload 406: image data, captured by a camera component of a client device 106 or retrieved from a memory component of a client device 106, and that is included in the message 400. Image data for a sent or received message 400 may be stored in the image table 312.
message video payload 408: video data, captured by a camera component or retrieved from a memory component of the client device 106, and that is included in the message 400. Video data for a sent or received message 400 may be stored in the video table 304.
message audio payload 410: audio data, captured by a microphone or retrieved from a memory component of the client device 106, and that is included in the message 400.
message augmentation data 412: augmentation data (e.g., filters, stickers, or other annotations or enhancements) that represents augmentations to be applied to message image payload 406, message video payload 408, or message audio payload 410 of the message 400. Augmentation data for a sent or received message 400 may be stored in the augmentation table 310.
message duration parameter 414: parameter value indicating, in seconds, the amount of time for which content of the message (e.g., the message image payload 406, message video payload 408, message audio payload 410) is to be presented or made accessible to a user via the messaging client 108.
message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image into within the message image payload 406, or a specific video in the message video payload 408).
message story identifier 418: identifier values identifying one or more content collections (e.g., “stories” identified in the story table 314) with which a particular content item in the message image payload 406 of the message 400 is associated. For example, multiple images within the message image payload 406 may each be associated with multiple content collections using identifier values.
message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
message sender identifier 422: an identifier (e.g., a messaging system identifier, email address, or device identifier) indicative of a user of the Client device 106 on which the message 400 was generated and from which the message 400 was sent.
message receiver identifier 424: an identifier (e.g., a messaging system identifier, email address, or device identifier) indicative of a user of the client device 106 to which the message 400 is addressed.

The contents (e.g., values) of the various components of message 400 may be pointers to locations in tables within which content data values are stored. For example, an image value in the message image payload 406 may be a pointer to (or address of) a location within an image table 312. Similarly, values within the message video payload 408 may point to data stored within a video table 304, values stored within the message augmentations 412 may point to data stored in an augmentation table 310, values stored within the message story identifier 418 may point to data stored in a story table 314, and values stored within the message sender identifier 422 and the message receiver identifier 424 may point to user records stored within an entity table 306.

Time-Based Access Limitation Architecture

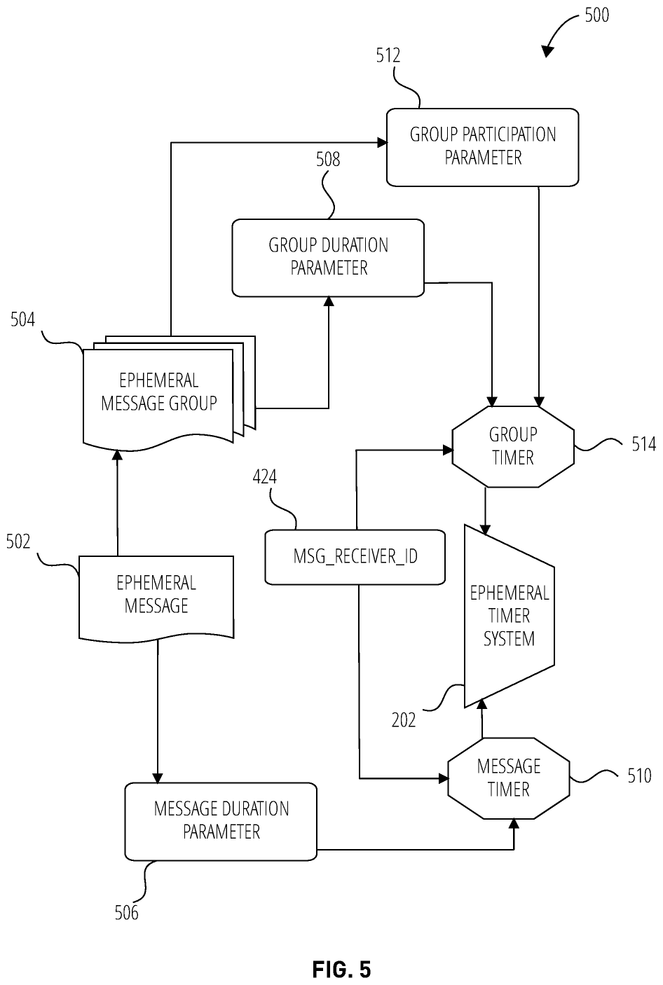

FIG. 5 is a schematic diagram illustrating an access-limiting process 500, in terms of which access to content (e.g., an ephemeral message 502, and associated multimedia payload of data) or a content collection (e.g., an ephemeral message group 504) may be time-limited (e.g., made ephemeral).

An ephemeral message 502 is shown to be associated with a message duration parameter 506, the value of which determines an amount of time that the ephemeral message 502 will be displayed to a receiving user of the ephemeral message 502 by the messaging client 108. In one example, an ephemeral message 502 is viewable by a receiving user for up to a maximum of 10 seconds, depending on the amount of time that the sending user specifies using the message duration parameter 506.

The message duration parameter 506 and the message receiver identifier 424 are shown to be inputs to a message timer 510, which is responsible for determining the amount of time that the ephemeral message 502 is shown to a particular receiving user identified by the message receiver identifier 424. In particular, the ephemeral message 502 will be shown to the relevant receiving user for a time period determined by the value of the message duration parameter 506. The message timer 510 is shown to provide output to a more generalized ephemeral timer system 202, which is responsible for the overall timing of display of content (e.g., an ephemeral message 502) to a receiving user.

The ephemeral message 502 is shown in FIG. 5 to be included within an ephemeral message group 504 (e.g., a collection of messages in a personal story, or an event story). The ephemeral message group 504 has an associated group duration parameter 508, a value of which determines a time duration for which the ephemeral message group 504 is presented and accessible to users of the messaging system 100. The group duration parameter 508, for example, may be the duration of a music concert, where the ephemeral message group 504 is a collection of content pertaining to that concert. Alternatively, a user (either the owning user or a curator user) may specify the value for the group duration parameter 508 when performing the setup and creation of the ephemeral message group 504.

Additionally, each ephemeral message 502 within the ephemeral message group 504 has an associated group participation parameter 512, a value of which determines the duration of time for which the ephemeral message 502 will be accessible within the context of the ephemeral message group 504. Accordingly, a particular ephemeral message group 504 may “expire” and become inaccessible within the context of the ephemeral message group 504, prior to the ephemeral message group 504 itself expiring in terms of the group duration parameter 508. The group duration parameter 508, group participation parameter 512, and message receiver identifier 424 each provide input to a group timer 514, which operationally determines, firstly, whether a particular ephemeral message 502 of the ephemeral message group 504 will be displayed to a particular receiving user and, if so, for how long. Note that the ephemeral message group 504 is also aware of the identity of the particular receiving user as a result of the message receiver identifier 424.

Accordingly, the group timer 514 operationally controls the overall lifespan of an associated ephemeral message group 504, as well as an individual ephemeral message 502 included in the ephemeral message group 504. In one example, each and every ephemeral message 502 within the ephemeral message group 504 remains viewable and accessible for a time period specified by the group duration parameter 508, in a further example, a certain ephemeral message 502 may expire, within the context of ephemeral message group 504, based on a group participation parameter 512. Note that a message duration parameter 506 may still determine the duration of time for which a particular ephemeral message 502 is displayed to a receiving user, even within the context of the ephemeral message group 504. Accordingly, the message duration parameter 506 determines the duration of time that a particular ephemeral message 502 is displayed to a receiving user, regardless of whether the receiving user is viewing that ephemeral message 502 inside or outside the context of an ephemeral message group 504.

The ephemeral timer system 202 may furthermore operationally remove a particular ephemeral message 502 from the ephemeral message group 504 based on a determination that it has exceeded an associated group participation parameter 512. For example, when a sending user has established a group participation parameter 512 of 24 hours from posting, the ephemeral timer system 202 will remove the relevant ephemeral message 502 from the ephemeral message group 504 after the specified 24 hours. The ephemeral timer system 202 also operates to remove an ephemeral message group 504 when either the group participation parameter 512 for each and every ephemeral message 502 within the ephemeral message group 504 has expired, or when the ephemeral message group 504 itself has expired in terms of the group duration parameter 508.

In certain use cases, a creator of a particular ephemeral message group 504 may specify an indefinite group duration parameter 508. In this case, the expiration of the group participation parameter 512 for the last remaining ephemeral message 502 within the ephemeral message group 504 will determine when the ephemeral message group 504 itself expires. In this case, a new ephemeral message 502, added to the ephemeral message group 504, with a new group participation parameter 512, effectively extends the life of an ephemeral message group 504 to equal the value of the group participation parameter 512.

Responsive to the ephemeral timer system 202 determining that an ephemeral message group 504 has expired (e.g., is no longer accessible), the ephemeral timer system 202 communicates with the messaging system 100 (and, for example, specifically the messaging client 108) to cause an indicium (e.g., an icon) associated with the relevant ephemeral message group 504 to no longer be displayed within a user interface of the messaging client 108. Similarly, when the ephemeral timer system 202 determines that the message duration parameter 506 for a particular ephemeral message 502 has expired, the ephemeral timer system 202 causes the messaging client 108 to no longer display an indicium (e.g., an icon or textual identification) associated with the ephemeral message 502.

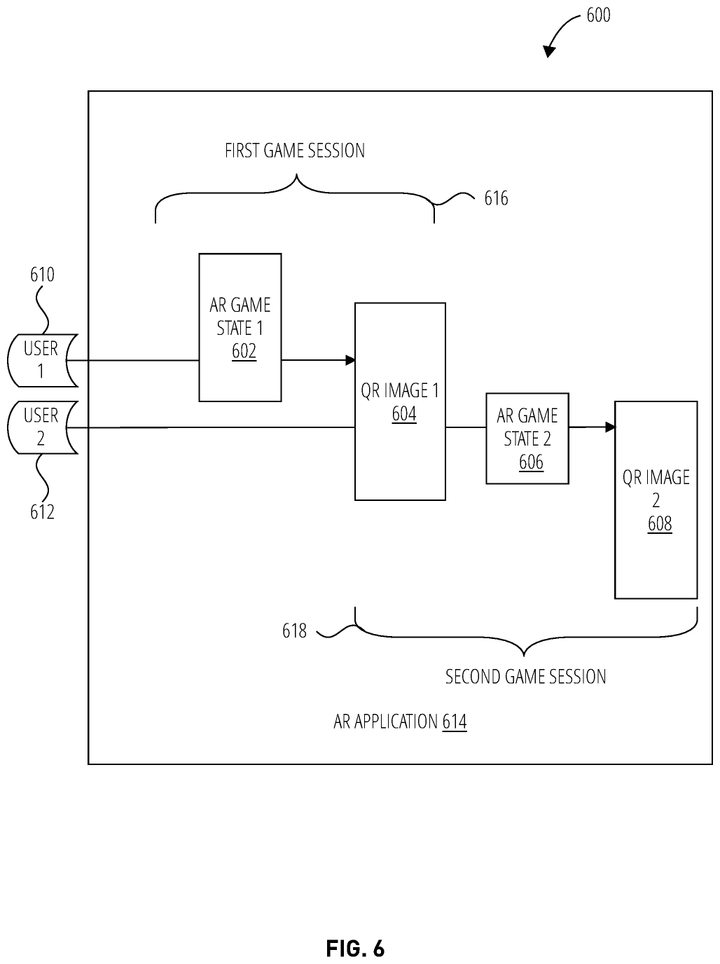

FIG. 6 illustrates a diagrammatic representation 600 of at least some details of the QR generation system 214 in accordance with some examples. In some examples, user 1 (610) and user 2 (612) are users of at least one mobile device that are actively signed into and engaged in an AR Application 614 hosted by the application servers 110 or hosted locally via the messaging client 108. User 1 (610) and user 2 (612) are each connected to the social network server 120, application servers 110, or third-party application 1440.

The mobile device can be a computing device, such as a smartphone, tablet, laptop, wearable device, or the like. The AR Application 614 can be any AR application formatted and configured for augmented reality or virtual reality (VR), such as an AR/VR game, AR/VR online seminar, AR/VR, on-demand video, AR/VR simulation, or an interactive AR/VR experience. For illustrative purposes, the AR Application 614 shown in FIG. 6 is an AR game.

As shown in FIG. 6, User 1 (610) interactively engages and participates in user activity during a first game session 616 of the AR game 614. The user activity in the first game session 616 is converted into AR game state 1 (602) and AR game state 2 (1102), as shown in FIG. 6. The AR game state 1 (602) corresponds to the user 1 (610) activity, engagement, progress, participation, user generated details, and user status made during an active game session of an AR Application 614.

In other examples, the AR game state 1 (602) represents a full or partial augmented reality environment, AR objects, AR details, AR graphics, and AR characteristics of the AR game 614 at the time of converting the user activity into AR game state 1 (602). The user activity can be converted into AR game state 1 (602) automatically by the QR generation system 214, manually by a user of the computing device (e.g., User 1 (610) or user 2 (612)), or based on a predetermined time interval. At the conclusion of the AR game state 1 (602), the QR generation system 214 generates a QR image 1 (604). The conclusion of the AR game state 1 (602) is determined by the User 1 (610) manually by signing out of the AR game 614 or automatically by the AR Application 614.

In some examples, the QR image 1 (604) is an image is a machine-readable optical configuration of two-dimensional or three-dimensional code resembling polygonal shapes and graphical configurations. The graphical configurations can be in the form of squares, rectangles, triangles, or other shapes that contain numeric, alphanumeric, byte/binary, or kanji characteristics. The QR image 1 (604) can also be a two-dimensional or three-dimensional photograph, digital image, object, animation, overlay, or video.

The QR image 1 (604) is encoded with the AR game state 1 (602) associated with the user activity completed during the first game session 616. Once the QR image 1 (604) is generated, User 1 610 can share the QR image 1 (604) with a second user by transmitting the QR image 1 (604) directly to the second user's device or by posting the QR image 1 (604) to the messaging client 108 or messaging application 1446.

Still referring to FIG. 6, User 1 610 transmits the QR image 1 (604) to User 2 612 User 2 actively signs into the AR Application 614, such as AR game 614, during a second game session 618. The second game session 618 is a new game session of the AR 614 that is interactive during a different time from the first game session 616. After the user 2 612 activates the QR image 1 (604), the AR game 614 is updated and constructed to reflect the AR game state 1 602 achieved by the user 1 610 during the first game session 616. The updated AR game 614 contains the full display of the augmented reality environment, AR objects, AR details, AR graphics, and AR characteristics of the AR game state 1 602. The user 2 612 can repeat the process of interactively engaging and participating in user activity during the second game session 618 beginning from the AR game state 1 602 achieved by the user 1 610. The new user activity generated by the user 2 612 can be converted into AR game state 2 606 and subsequently used to generate the QR image 2 608.

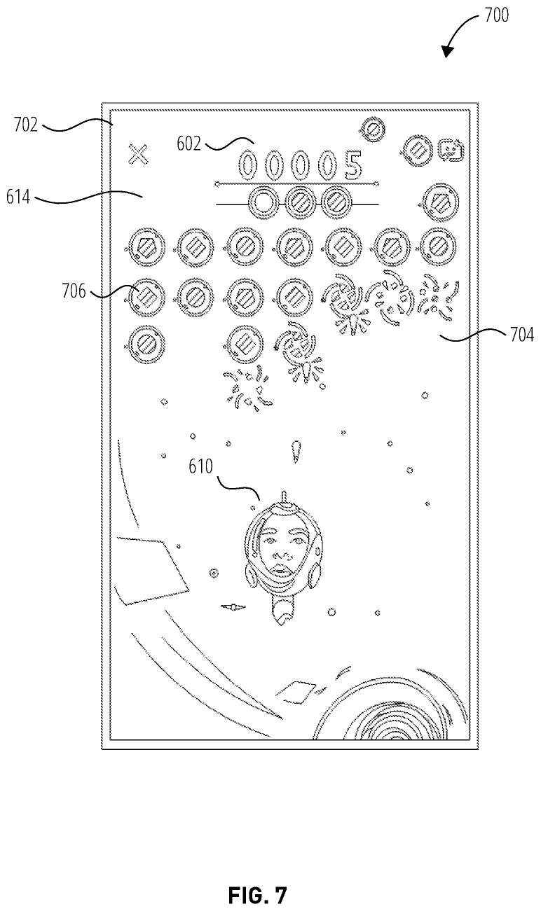

FIG. 7 is an interface diagram 700 illustrating a user interface of the AR application interface 702 displaying a user actively engaged in an AR Application 614 in accordance with some examples. The user 1 610 is depicted as an AR game character 610 overlaid within a spaceship that is actively engaged in the user activity 704 of shooting down AR obstacles 706 generated by the AR Application 614. AR obstacles 706 is used as an example. It is to be understood that any AR characteristics, such as, AR objects, AR characters, AR structures. AR environment details, or AR backgrounds are associated with user activity 704 generated by the AR Application 614.

In one example, the AR Application 614 corresponds to the AR game 614 described in FIG. 6. The user activity 704 of the user 1 610 represents destroying AR obstacles 706 within the AR game 614. In one example, the AR game state 1 602 represents user activity 704 in the form of a score of “00005” as shown above the AR obstacles 706 within the AR Application 614. In some examples, the AR game state 1 602 the user activity 704 corresponds to the current configuration of the AR obstacles 706 and associated AR game 614 characteristics displayed by the AR application interface 702.

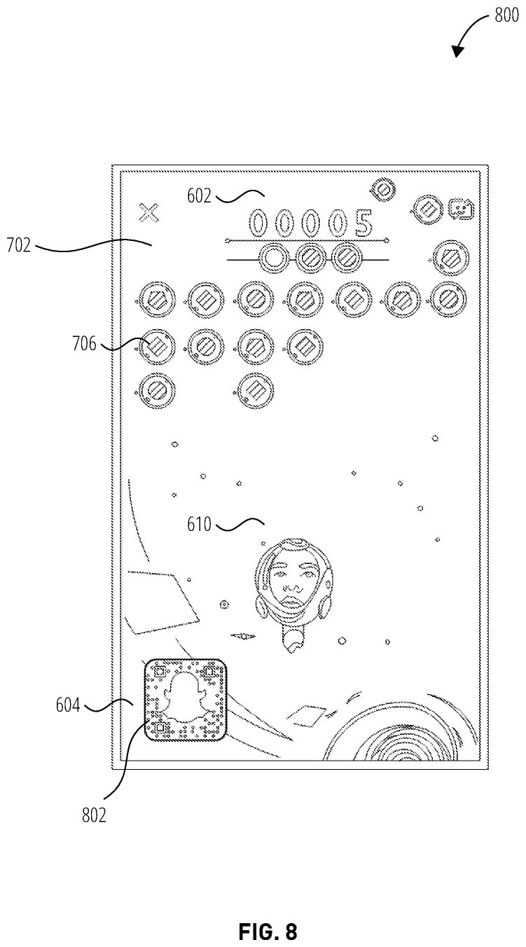

FIG. 8 is an interface diagram illustrating a user interface 800 of the AR application interface 702 displaying a user actively completing the AR Application 614 in accordance with some examples. For illustration purposes, FIG. 8 depicts the user 1 610 after completion of a first game session 616 of the AR game 614. The AR game state 1 602 represents the user activity 704 of the user 1 610 reflecting the number of AR obstacles 706 destroyed in the AR game 614, as well as the configuration of the AR obstacles 706 arranged in the AR application interface 702.

Still referring to FIG. 8, the QR image 1 (604) is generated and displayed in the AR application interface 702 so that the user 1 610 can share the QR image 1 (604) with other users actively or inactively engaged in the AR Application 614. The QR image 1 (604) includes a sequence of encoded AR state graphical elements 802 that are arranged and overlaid on top of the QR image 1 (604).

In some examples, the encoded AR state graphical elements 802 can be arranged in an alternate polygonal and transformative shape configuration within the QR image 1 (604). The encoded AR state graphical elements 802 correspond to the converted and encoded user activity representing the AR game state 1 602. As illustrated in the example AR image 1 (604) of FIG. 8, the AR game state 1 602 depicts fourteen AR obstacles 706 in a 3×7 matrix configuration and the incremented score of “00005.”

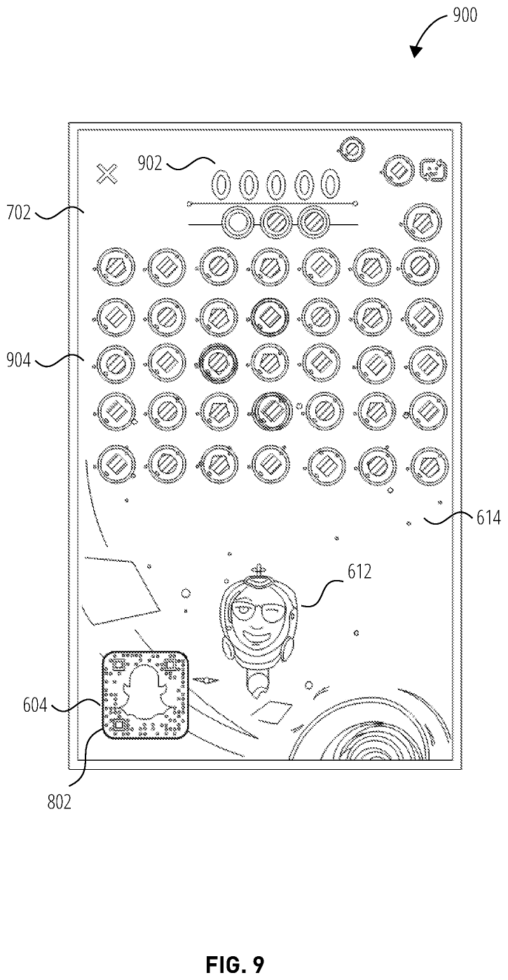

FIG. 9 is an interface diagram illustrating a user interface 900 of the AR application interface 702 displaying a second user 612 actively beginning a new session in the AR application 614 in accordance with some examples. FIG. 9 depicts user 2 612 signing into the AR game 614 without having accessed the QR image 1 (604) transferred to the user 2 612 by the user 1 610, In order to access the QR image 1 (604), user 2 612 applies a user gesture on the QR image 1 (604). The user gesture can include applying a pressing motion, hand-waiving motion, voice command, or eye-gaze motion on the QR image 1 (604), which contains the encoded AR state graphical elements 802.

As shown in FIG. 9, new AR obstacles 904 are arranged in a matrix or table format depicting the start, commencement, or initiation of a new game (e.g., a new game session). The new AR game state 902 is set to “00000” and the user 2 612 has yet to engage in any user activity with the AR game 614. In some examples, when the user 2 612 elects to continue user activity based on the AR game state 1 602 generated by the user 1 610, the user 2 612 can apply the user gesture on the QR image 1 (604) transferred to the user 2 612. In some examples, the QR image 1 (604) can be transferred to a single user, group of users, or a user based on a predetermined selection process.

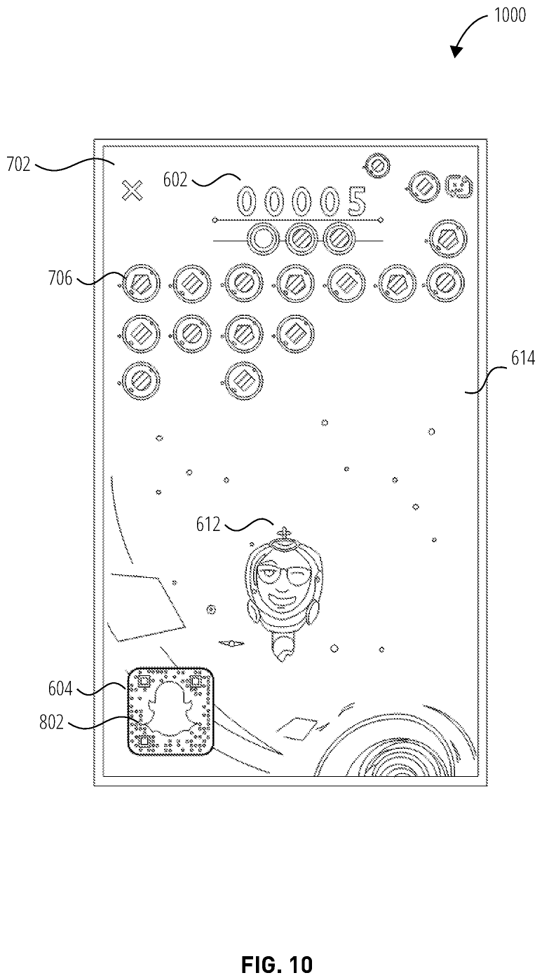

FIG. 10 is an interface diagram 1000 illustrating an AR application interface 702 displaying the user 2 612 selecting the QR image 604 in the new session of the AR application 614 in accordance with some examples. As a result of user 2 612 applying a user gesture (not shown) on the QR image 1 (604), the AR game state 1 602 encoded in the QR image 1 (604) is used to generate the exact AR environment, AR details, AR obstacles, and user activity that correspond to the encoded AR state graphical elements 802 converted from the user activity of user 1 610 conducted in the first game session 616 of the AR game 614.

For example, FIG. 10 depicts AR game state 1 602 with the AR game score at “00005” which was the same AR game score achieved in the first game session 616 of the AR Application 614 by user 1 610. Also, the same arrangement of AR obstacles 706 depicted at the conclusion of the first game session 616 shown in FIG. 8 that were converted and encoded into the encoded AR state graphical elements 802 of the QR image 1 (604) is generated in the AR application interface 702 of the AR game 614. The user 2 612 is now able to begin the interactive game play of the AR game 614 during the second session based on the AR game state 1 602 of the user 1 610 during the first game session 616.

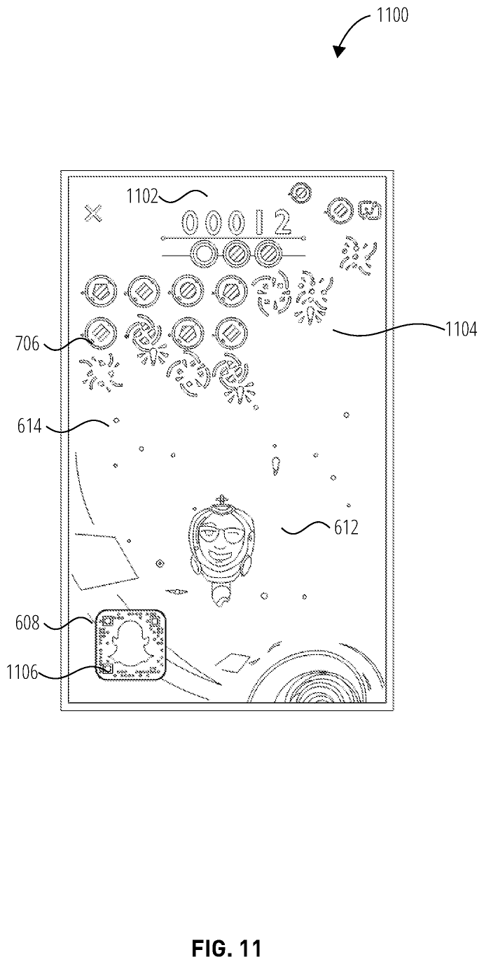

FIG. 11 is an interface diagram 1100 illustrating the AR application interface 702 displaying the second user 612 actively engaged in the AR application during the second session after accessing the QR image 604 in accordance with some examples. The user 2 612 conducts new user activity 1104 which is depicted as destroying AR obstacles 706 arranged in the AR game 614. User 2 612 performs the new user activity 1104 based on the arrangement of the AR obstacles 706 generated from the AR game state 1 (602). As the user 2 612 performs new user activity 1104, a new AR game state 2 1102 is generated.

Still referring to FIG. 11, the new AR game state 2 1102 depicts the score of “00012” after being incremented from “00005” as originally displayed in the AR game state 1 (602), The AR obstacles 706 are also reduced from fourteen to six. As user 2 612 completes the new user activity 1104, the new user activity 1104 is converted into the AR game state 2 1102. After the conversion. QR image 2 608 is generated and the AR game state 2 1102 is encoded into the QR image 2 608 as new encoded AR state graphical elements 1106 overlaid on top, and integrated within the QR image 2 608.

In some examples, the QR image 1 (604) can be updated with the new encoded AR state graphical elements 1106 as opposed to generating QR image 2 608. When updating the QR image 1 (604) with the new encoded AR state graphical elements 1106, the encoded AR state graphical elements 802 is removed and replaced with new encoded AR state graphical elements 1106.

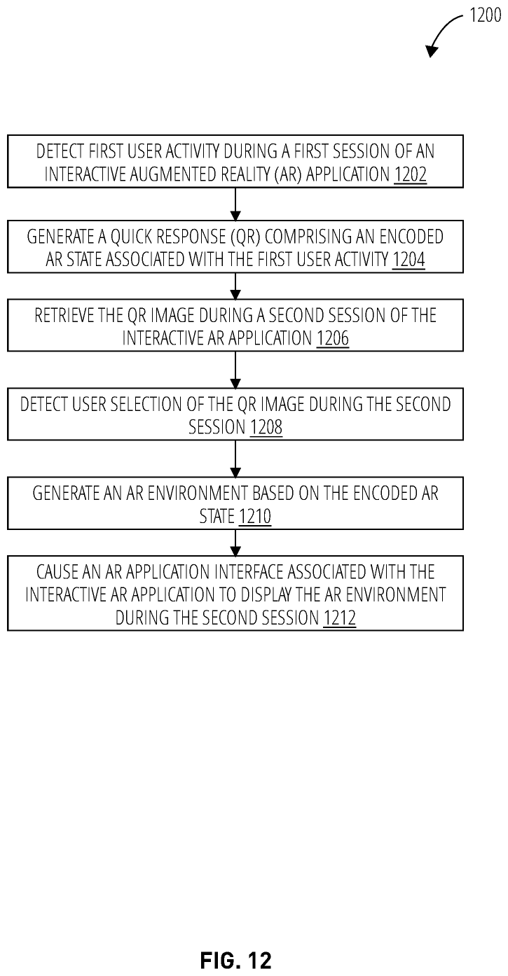

FIG. 12 is a flowchart illustrating a method 1200 for generating a QR image associated with an AR application state in accordance with some examples. While certain operations of the method 1200 are described as being performed by certain devices, in different examples, different devices or a combination of devices may perform these operations. For example, operations described below as being performed by the client device 106 may also be performed by or in combination with server-side computing device (e.g., the message messaging server system 104), or third-party server computing device.

In operation 1202, a computing device (e.g., client device 106 or a server in server system 104) detects, using one or more processors, first user activity executed by a first computing device during a first session of an interactive augmented reality (AR) application. For example, a user can initiate a first session of an AR application on a client device 106. The client device detects the user activity during the first session and/or a server system detects the user activity during the first session of the AR application on the client device 106. In some examples, user activity can correspond to any activity, progress, manipulation, motion, examination, or action conducted during an active session, such as a first or second session, of a AR application, VR application, Mixed-reality application, three-dimensional application, or two-dimensional application.

In other examples, user activity can also correspond to interacting with at least one graphical component rendered in the AR application, VR application, Mixed-reality (MR) application, three-dimensional (3D) application, or two-dimensional (2D) application. Although a first and second session is described, the QR generation system 214 can implement the operations on an indefinite amount of game session, such as a third game session, fourth game session, fifth game session, and so on. The graphical components can include content items, image overlays, image transformations, images, object, or informational components. Interacting with the graphical components can also include adding, removing, or manipulation of the graphical components within the AR, VR, MR, 3D, or 2D environments.

For example, a first user activity can be related to building a portion of a castle during a first round in an interactive augmented reality castle building game experience. The user activity also represents the digital structure, graphical environment, graphical background, foreground, graphical objects, and statistics constructed and arranged in the AR Application 614 as a result of the user's progress, activity, or action made during a game session of the AR. Application 614.

In some examples, the detection of user activity is implemented by image analysis techniques utilizing optical sensors. The interactive AR application can be any software application formatted and configured in augmented reality (AR), mixed-reality environment, or virtual reality (VR) environment. The AR application can also be any application formatted and configured two-dimensional or three-dimensional coordinate plane or environment.

The AR application can also be an AR game application, such as the AR game 614 illustrated in FIG. 7 which can contain AR content items, image overlays, image transformations, AR images, and AR objects. Although augmented reality content items, image overlays, image transformations, images, and objects are described as being formatted components in an AR environment, these components can be formatted and configured in a two-dimensional environment, three-dimensional environment, mixed-reality environment, or virtual environment.

In operation 1204, the computing device generates a quick response (QR) image, the QR image comprising an encoded information representing the AR state associated with the first user activity. In some examples, the QR image is a QR code that is machine-readable encoded as an optical label. The encoded information is constructed as polygonal shapes and graphical configurations. The graphical configurations can be in the form of squares, rectangles, triangles, or other shapes that contain numeric, alphanumeric, byte/binary, or kanji characteristics. The QR image can also be a two-dimensional or three-dimensional photograph, digital image, object, animation, overlay, or video.

In some examples, the encoded AR state represents the encoded information corresponding to the user's activity conducted and implemented during the first session of the AR application. The user activity, which converted into AR game state 1 602 and AR game state 2 (606), as shown in FIG. 6, corresponds to the user's activity, engagement, progress, participation, user generated details, and user status made during an active game session of an AR Application 614. The active game session can be the first game session 616 or second game session 618 as illustrated in FIG. 6.

In operation 1206, the computing device retrieves the QR image during a second session of the interactive AR application. The QR generation system 214 can retrieve QR image from the database 122, client device 106, third-party application 1440, or third-party server. In other examples, the QR image can be retrieved from the AR application interface 702. In some examples, the first or second game session can be terminated prior to or after initiation of the first or second game session.

In operation 1208, the computing device detects selection of the QR image during the second session. For example, the computing device can detect a user gesture on the QR image indicating a user selection of the QR image. The user gesture can include a finger pressing motion, a hand-waiving motion, a voice command, an eye-gaze motion, or the like, on the QR image.

Still referring to FIG. 12, responsive to detecting the user selection of the QR image, in operation 1210, the computing device generates an AR environment based on the encoded AR state. For example, the QR generation system 214 can communicate with the augmentation system 206, game system 212, and messaging system 100 to generate the AR environment utilizing object recognition techniques, computer vision, and augmented reality sensory analysis and cameras.

In some examples, although the AR environment that directly corresponds to the AR state is generated, any interactive graphical environment can be generated, such as, a virtual reality environment, two-dimensional environment, or a three-dimensional environment. The generated graphical environment (e.g., AR environment) represents the digital characteristics, digital objects, digital characters, digital structures, digital details that are rendered at the time of the associated user activity 704 generated by the user (e.g., user 1 610 or user 2 612) of the AR Application 614. In operation 1212, the computing device causes an AR application interface associated with the interactive AR application to display the AR environment during the second session.

Machine Architecture

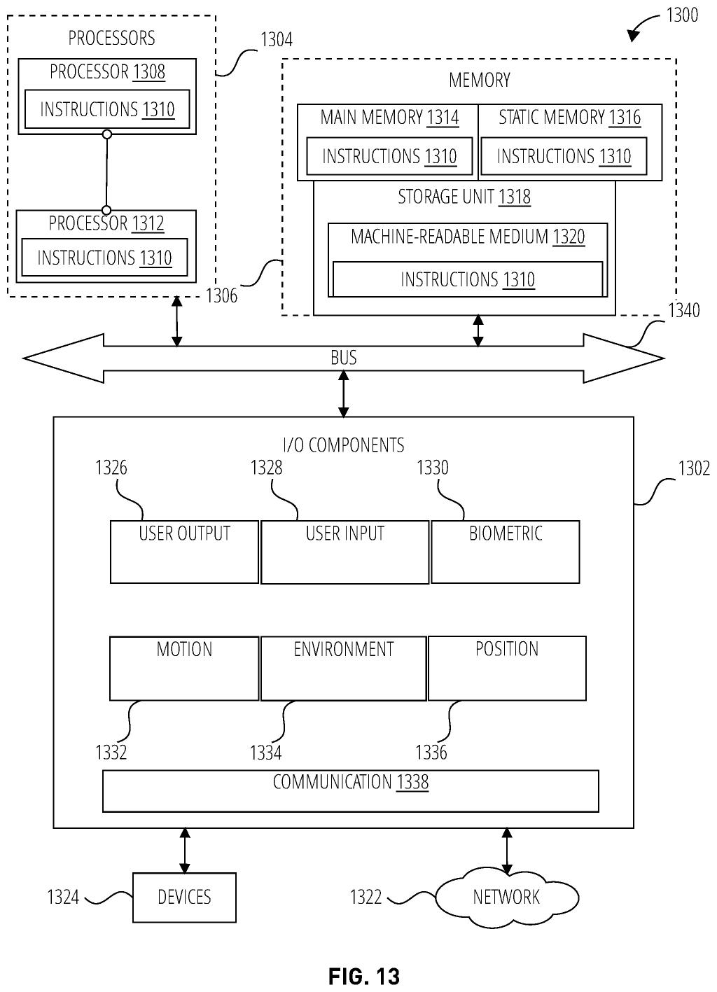

FIG. 13 is a diagrammatic representation of the machine 1300 within which instructions 1310 (e.g., software, a program, an application, an applet, an app, or other executable code) for causing the machine 1300 to perform any one or more of the methodologies discussed herein may be executed. For example, the instructions 1310 may cause the machine 1300 to execute any one or more of the methods described herein. The instructions 1310 transform the general, non-programmed machine 1300 into a particular machine 1300 programmed to carry out the described and illustrated functions in the manner described. The machine 1300 may operate as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1310, sequentially or otherwise, that specify actions to be taken by the machine 1300, Further, while only a single machine 1300 is illustrated, the term “machine” shall also be taken to include a collection of machines that individually or jointly execute the instructions 1310 to perform any one or more of the methodologies discussed herein. The machine 1300, for example, may comprise the client device 106 or any one of a number of server devices forming part of the messaging server system 104. In some examples, the machine 1300 may also comprise both client and server systems, with certain operations of a particular method or algorithm being performed on the server-side and with certain operations of the particular method or algorithm being performed on the client-side.

The machine 1300 may include processors 1304, memory 1306, and input/output I/O components 638, which may be configured to communicate with each other via a bus 1340. In an example, the processors 1304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1308 and a processor 1312 that execute the instructions 1310. The term “processor” is intended to include multi-core processors that may comprise two or more independent processors (sometimes referred to as “cores”) that may execute instructions contemporaneously. Although FIG. 13 shows multiple processors 1304, the machine 1300 may include a single processor with a single-core, a single processor with multiple cores (e.g., a multi-core processor), multiple processors with a single core, multiple processors with multiples cores, or any combination thereof.

The memory 1306 includes a main memory 1314, a static memory 1316, and a storage unit 1318, both accessible to the processors 1304 via the bus 1340. The main memory 1306, the static memory 1316, and storage unit 1318 store the instructions 1310 embodying any one or more of the methodologies or functions described herein. The instructions 1310 may also reside, completely or partially, within the main memory 1314, within the static memory 1316, within machine-readable medium 1320 within the storage unit 1318, within at least one of the processors 1304 (e.g., within the Processor's cache memory), or any suitable combination thereof, during execution thereof by the machine 1300.

The I/O components 1302 may include a wide variety of components to receive input, provide output, produce output, transmit information, exchange information, capture measurements, and so on. The specific I/O components 1302 that are included in a particular machine will depend on the type of machine. For example, portable machines such as mobile phones may include a touch input device or other such input mechanisms, while a headless server machine will likely not include such a touch input device. It will be appreciated that the I/O components 1302 may include many other components that are not shown in FIG. 13. In various examples, the I/O components 1302 may include user output components 1326 and user input components 1328. The user output components 1326 may include visual components (e.g., a display such as a plasma display panel (PDP), a light-emitting diode (LED) display, a liquid crystal display (LCD), a projector, or a cathode ray tube (CRT)), acoustic components speakers), haptic components (e.g., a vibratory motor, resistance mechanisms), other signal generators, and so forth. The user input components 1328 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1302 may include biometric components 1330, motion components 1332, environmental components 1334, or position components 1336, among a wide array of other components. For example, the biometric components 1330 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1332 include acceleration sensor components (e.g., accelerometer), gravitation sensor components, rotation sensor components (e.g., gyroscope).

The environmental components 1334 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client device 106 may have a camera system comprising, for example, front cameras on a front surface of the client device 106 and rear cameras on a rear surface of the client device 106. The front cameras may, for example, be used to capture still images and video of a user of the client device 106 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the client device 106 may also include a 360° camera for capturing 360° photographs and videos.

Further, the camera system of a client device 106 may include dual rear cameras (e.g., a primary camera as well as a depth-sensing camera), or even triple, quad or penta rear camera configurations on the front and rear sides of the client device 106. These multiple cameras systems may include a wide camera, an ultra-wide camera, a telephoto camera, a macro camera and a depth sensor, for example.

The position components 1336 include location sensor components (e.g., a UPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1302 further include communication components 1338 operable to couple the machine 1300 to a network 1322 or devices 1324 via respective coupling or connections. For example, the communication components 1338 may include a network interface Component or another suitable device to interface with the network 1322. In further examples, the communication components 1338 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1324 may be another machine or any of a wide variety of peripheral devices (e.g., a peripheral device coupled via a USB).

Moreover, the communication components 1338 may detect identifiers or include components operable to detect identifiers. For example, the communication components 1338 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1338, such as location via Internet Protocol (IP) geolocation, location via Wi-Fi® signal triangulation, location via detecting an NFC beacon signal that may indicate a particular location, and so forth.

The various memories (e.g., main memory 1314, static memory 1316, and memory of the processors 1304) and storage unit 1318 may store one or more sets of instructions and data structures (e.g., software) embodying or used by any one or more of the methodologies or functions described herein. These instructions (e.g., the instructions 1310), when executed by processors 1304, cause various operations to implement the disclosed examples.

The instructions 1310 may be transmitted or received over the network 1322, using a transmission medium, via a network interface device (e.g., a network interface component included in the communication components 1338) and using any one of several well-known transfer protocols (e.g., hypertext transfer protocol (HTTP)), Similarly, the instructions 1310 may be transmitted or received using a transmission medium via a coupling (e.g., a peer-to-peer coupling) to the devices 1324.

Software Architecture

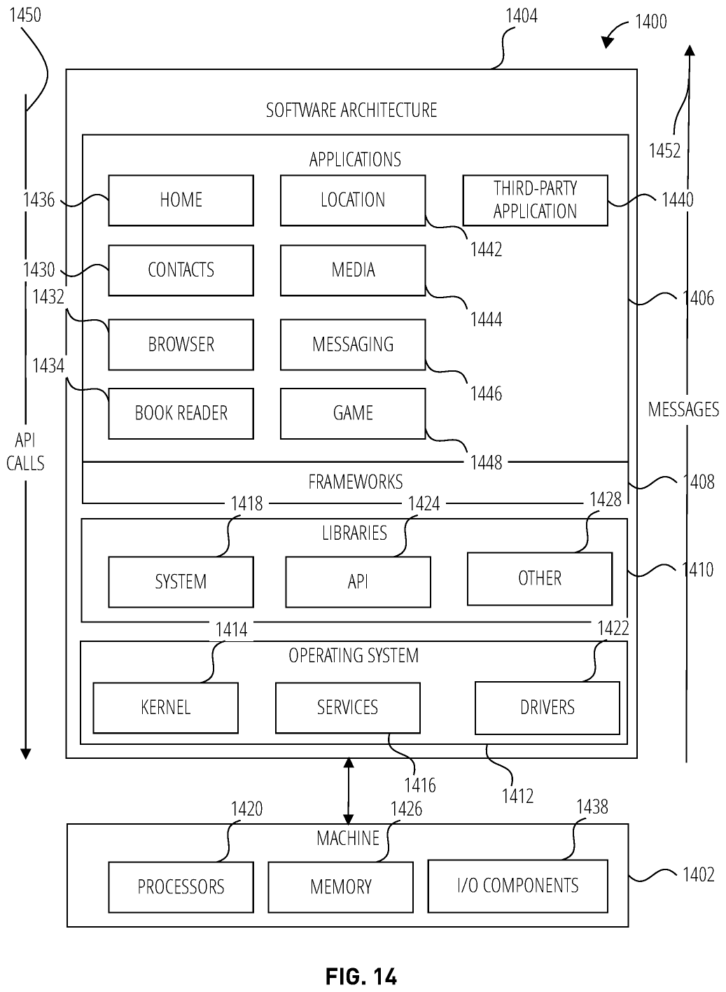

FIG. 14 is a block diagram 1400 illustrating a software architecture 1404, which can be installed on any one or more of the devices described herein. The software architecture 1404 is supported by hardware such as a machine 1402 that includes processors 1420, memory 1426, and I/O components 1438. In this example, the software architecture 1404 can be conceptualized as a stack of layers, where each layer provides a particular functionality. The software architecture 1404 includes layers such as an operating system 1412, libraries 1410, frameworks 1408, and applications 1406. Operationally, the applications 1406 invoke API calls 1450 through the software stack and receive messages 1452 in response to the API calls 1450.

The operating system 1412 manages hardware resources and provides common services. The operating system 1412 includes, for example, a kernel 1414, services 1416, and drivers 1422. The kernel 1414 acts as an abstraction layer between the hardware and the other software layers. For example, the kernel 1414 provides memory management, processor management (e.g., scheduling), component management, networking, and security settings, among other functionality. The services 1416 can provide other common services for the other software layers. The drivers 1422 are responsible for controlling or interfacing with the underlying hardware. For instance, the drivers 1422 can include display drivers, camera drivers, BLUETOOTH® or BLUETOOTH® Low Energy drivers, flash memory drivers, serial communication drivers USB drivers), WI-FI® drivers, audio drivers, power management drivers, and so forth.

The libraries 1410 provide a common low-level infrastructure used by the applications 1406. The libraries 1410 can include system libraries 1418 (e.g., C standard library) that provide functions such as memory allocation functions, string manipulation functions, mathematic functions, and the like. In addition, the libraries 1410 can include API libraries 1424 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1410 can also include a wide variety of other libraries 1428 to provide many other APIs to the applications 1406.

The frameworks 1408 provide a common high-level infrastructure that is used by the applications 1406. For example, the frameworks 1408 provide various graphical user interface (GUI) functions, high-level resource management, and high-level location services. The frameworks 1408 can provide a broad spectrum of other APIs that can be used by the applications 1406, some of which may be specific to a particular operating system or platform.

In an example, the applications 1406 may include a home application 1436, a contacts application 1430, a browser application 1432, a book reader application 1434, a location application 1442, a media application 1444, a messaging application 1446, a game application 1448, and a broad assortment of other applications such as a third-party application 1440. The applications 1406 are programs that execute functions defined in the programs. Various programming languages can be employed to create one or more of the applications 1406, structured in a variety of manners, such as object-oriented programming languages (e.g., Objective-C, Java, or C++) or procedural programming languages (e.g., C or assembly language). In a specific example, the third-party application 1440 (e.g., an application developed using the ANDROM™ or IOS™ software development kit (SDK) by an entity other than the vendor of the particular platform) may be mobile software running on a mobile operating system such as IOS™, ANDROID™, WINDOWS®, Phone, or another mobile operating system. In this example, the third-party application 1440 can invoke the API calls 1450 provided by the operating system 1412 to facilitate functionality described herein.

Processing Components

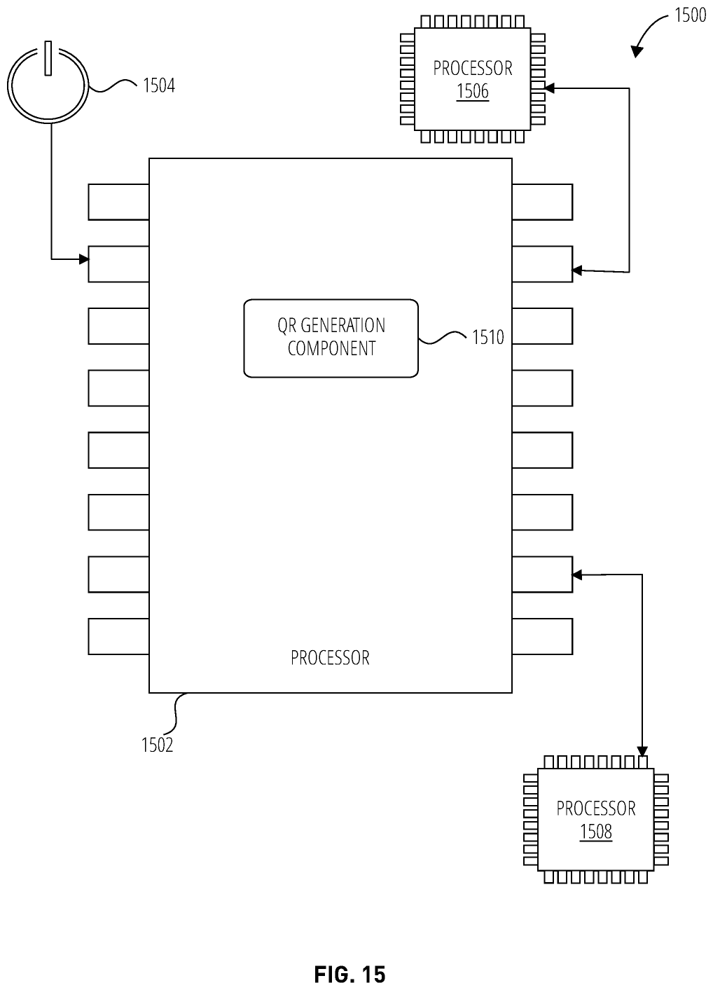

Turning now to FIG. 15, there is shown a diagrammatic representation of a processing environment 1500, which includes a processor 1502, a processor 1506, and a processor 1508 (e.g., a GPU, CPU or combination thereof).

The processor 1502 is shown to be coupled to a power source 1504, and to include (either permanently configured or temporarily instantiated) modules, namely a QR generation component 1510. The QR generation component 1510 operationally detects first user activity executed by a first computing device during a first session of an interactive augmented reality (AR) application, generates a quick response (QR) image, the QR image comprising an encoded AR state associated with the first user activity, retrieves the QR image during a second session of the interactive AR application, detects user selection of the QR image during the second session, responsive to detecting the user selection of the QR image, generates an AR environment based on the encoded AR state, and causes an AR application interface associated with the interactive AR application to display the AR environment during the second session. As illustrated, the processor 1502 is communicatively coupled to both the processor 1506 and the processor 1508.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third. Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
detecting, using one or more processors, first user activity during a first session of an interactive augmented reality (AR) application on a first computing device;
generating a quick response (QR) image comprising an encoded AR state associated with the first user activity;
retrieving the QR image during a second session of the interactive AR application;
detecting selection of the QR image during the second session;
responsive to detecting the selection of the QR image, generating an AR environment based on the encoded AR state; and
causing an AR application interface associated with the interactive AR application to display the AR environment during the second session.

2. The method of claim 1, wherein after generating the QR image comprising the encoded AR state of the first user activity the method comprises:
initiating a third session of the interactive AR application;
retrieving the QR image during the third session;
detecting a second selection of the QR image during the third session; and
responsive to detecting the second selection of the QR image, causing the encoded AR state to display the first user activity during the third session of the interactive AR application.

3. The method of claim 1, wherein responsive to displaying the AR environment during the second session, detecting second user activity during a commencement of the second session.

4. The method of claim 3, wherein the first user activity comprises interacting with at least one AR content item, image overlay, image transformation, AR image, or AR object.

5. The method of claim 1, wherein the interactive AR application is an AR game application, the AR game application comprising AR content items, image overlays, image transformations, AR images, and AR objects.

6. The method of claim 1, wherein the encoded AR state comprises a game status based on the interaction with the at least one of the AR content items, the image overlays, the image transformations, the AR images, or the AR objects.

7. The method of claim 1, wherein the QR image comprises a three-dimensional object component.

8. The method of claim 3, further comprising:
generating a second QR image based on the second user activity.

9. The method of claim 1, further comprising:
transmitting the QR image to a third computing device;
detecting a third selection of the QR image by the third computing device during a third session of the interactive AR application; and
responsive to detecting the third selection of the QR image during the third session, causing the encoded AR state to display the first user activity during the third session of the interactive AR application.

10. The method of claim 8, further comprising:
updating the second QR image with a second encoded AR state based on the second user activity;
transmitting the QR image to a third computing device;
detecting a third selection of the QR image during a third session of the interactive AR application; and
responsive to detecting the third selection of the QR image during the third session, causing the first and second encoded AR states to display the first and second user activity during the third session of the interactive AR application.

11. The method of claim 4, wherein the interacting with at least one of the AR content items, the image overlays, the image transformations, the AR images, or the AR objects comprises adding and removing at least one of the AR content items, the image transformations, the AR images, or the AR objects in the interactive AR applications.

12. The method of claim 1, further comprising:
terminating the second session;
initiating a third session; and
retrieving the QR image during the third session.

13. A system comprising:
a processor; and
a memory storing instructions that, when executed by the processor, configure the system to perform operations comprising:
detecting, using one or more processors, first user activity during a first session of an interactive augmented reality (AR) application on a first computing device;
generating a quick response (QR) image comprising an encoded AR state associated with the first user activity;
retrieving the QR image during a second session of the interactive AR application;
detecting selection of the QR image during the second session;
responsive to detecting the selection of the QR image, generating an AR environment based on the encoded AR state; and
causing an AR application interface associated with the interactive AR application to display the AR environment during the second session.

14. The system of claim 13, wherein the instructions further configure the system to perform operations comprising:
initiating a third session of the interactive AR application;
retrieving the QR image during the third session;
detecting a second user selection of the QR image during the third session; and
responsive to detecting the second selection of the QR image, causing the encoded AR state to display the first user activity during the third session of the interactive AR application.

15. The system of claim 13, wherein the interactive AR application is an AR game application, the AR game application comprising AR content items, image overlays, image transformations, AR images, and AR objects.

16. The system of claim 13, wherein the first user activity comprises interact with at least one AR content item, image overlay, image transformation, AR image, or AR object.

17. The system of claim 15, wherein the encoded AR state comprises a game status based on the interaction with the at least one of the AR content items, the image overlays, the image transformations, the AR images, or the AR objects.

18. The system of claim 16, wherein the instructions further configure the system to perform operations comprising:
transmitting the QR image to a third computing device;
detecting user selection of the QR image by the third computing device during a third session of the interactive AR application; and
responsive to detecting the user selection of the QR image during the third session, causing the encoded AR state to display the first user activity during the third session of the interactive AR application.

19. The system of claim 16, wherein the instructions further configure the system to perform operations comprising:
updating the QR image with a second encoded AR state based on the second user activity;
transmitting the QR image to a third computing device;
detecting user selection of the QR image during a third session of the interactive AR application; and
responsive to detecting the user selection of the QR image during the third session, causing the first and second encoded AR state to display the first and second user activity during the third session of the interactive AR application.

20. A non-transitory computer-readable storage medium, the computer-readable storage medium including instructions that when executed by a computer, cause the computer to perform operations comprising:
detecting, using one or more processors, first user activity during a first session of an interactive augmented reality (AR) application on a first computing device;
generating a quick response (QR) image comprising an encoded AR state associated with the first user activity;
retrieving the QR image during a second session of the interactive AR application;
detecting selection of the QR image during the second session;
responsive to detecting the selection of the QR image, generating an AR environment based on the encoded AR state; and
causing an AR application interface associated with e interactive AR application to display the AR environment during the second session.
